(19) United States
(12) Patent Application Publication
(10) Pub. No.: US 2010/0261289 A1
(43) Pub. Date: Oct. 14, 2010

(54) WATER-SOLUBLE POLYMERS HAVING CHELATORS

(75) Inventors: Roland Fabis, Hilden (DE); Bernd Springer, Hilden (DE)

Correspondence Address: Fanelli Strain & Haag PLLC, 1455 Pennsylvania Ave., N.W., suite 400, Washington, DC, 20004, US

(73) Assignee: QIAGEN GMBH

(21) Appl. No.: 12/680,932

(22) PCT Filed: Oct. 10, 2008
(86) PCT No.: PCT/EP08/63665

§ 371 Date: May 28, 2010

(30) Foreign Application Priority Data
Oct. 12, 2007 (DE) 10 2007 049 335.7

(51) Int. Cl. G01N 21/00; C08F 12/08; C08F 10/06; C08F 20/18; C08F 20/56

(52) U.S. Cl. 436/169; 525/333.6; 525/333.7; 525/329.9; 525/329.4

(57) ABSTRACT

The present invention relates to a functionalized polymer having a high solubility in at least one solvent having high E_{τ}(30) value, and being functionalized with at least one N-containing carboxylate chelator.

### FIELD OF THE INVENTION

The present invention relates to the field of functionalized polymers, in particular those polymers which are able to bind biomolecules.

### TECHNICAL BACKGROUND

For many purification or assay applications of biomolecules on the multiplex scale, the use of modified microtiter plates for the at least temporary immobilization of the biomolecules is advantageous. In order to chemically modify microtiter plates for covalent immobilization of biomolecules, according to the prior art, either complex chemical modification methods, such as carboxymethylation, are required, or complex instruments for irradiation of the plates.

### OBJECT OF THE PRESENT INVENTION

The object of the present invention is to overcome the described disadvantages arising from the prior art and in particular to provide a functionalized water-soluble polymer or copolymer for a wide range of applications which, simply by being added by pipetting in aqueous or organic solution, is able to coat plastic surfaces and other surfaces.

The object is achieved by a functionalized polymer according to claim 1 of the present invention. Accordingly, a functionalized polymer is provided which has a solubility of ≧10 mg/ml in at least one solvent having an E_{T}(30) value of ≧45 to ≧65 and is functionalized with at least one N-containing carboxylate chelator.

Within the context of the present invention, “E_{T}(30) value” is understood in particular as meaning the polarity of a solvent, reference being made within the context of the present invention to the values which have been published in Reichart; Dimroth Fortschr. Chem. Forsch. 1969, 11, 1-73, Reichart Angew. Chem. 1979, 91, 119 -131 and also cited in March, Advanced Organic Chemistry, 4th edition, J. Wiley & Sons, 2001, Table 10.13, p. 453. Preferred solvents (according to a correspondingly preferred embodiment of the present invention) are water (pH=7) and ethanol.

An “N-containing carboxylate chelator” is understood in particular as meaning a molecular unit which has one or more carboxyl and/or carboxylic acid units and also one or more amine units.

A functionalized polymer of this type offers at least one of the following advantages for a wide range of applications within the present inventions:
As a result of the fact that the solubility is within the stated limits, the polymer can often be applied simply by pipetting on a glass or plastic surface (for example a microtiter plate); however, within a wide range of applications of the present invention, the polymer can also be removed again very easily.
As a result of the at least one chelator, the polymer is able within a wide range of applications of the present invention to bind biomolecules reversibly and/or irreversibly depending on the application conditions. This method permits the plastic material used for the binding, purification or detection to be chosen freely since no plastic surfaces pretreated with functional group have to be used.
As a result of the simple coating process from the polymer solution that is not linked to certain formats, the invention described here is suitable within a wide range of applications in a particular manner for applications in the microfluidic sector.
Coating by simply pipetting in and removing the liquid can be carried out without adding expensive and relatively complex instruments. For example, no plasma generator, radiation source or aggressive gases such as ozone are required.

According to one preferred embodiment of the invention, the functionalized polymer has a solubility of ≧25 mg/ml, preferably ≧50 mg/ml, and most preferably ≧100 mg/ml in at least one solvent with an E_{T}(30) value of ≧48 to 65, and most preferably ≧50 to ≧65.

According to one preferred embodiment of the invention, the polymer has a chelator concentration of ≧2% by weight to ≧75% by weight. Here, where appropriate, the “chelator” is understood as meaning just the chelating group (such as e.g. an iminoacetic acid unit; for more, see below).

Preferably, the polymer has a chelator concentration of ≧5% by weight to ≦70% by weight, more preferably ≧10% by weight to ≦50% by weight.

This has proven to be advantageous for many embodiments of the present invention.

According to one preferred embodiment of the invention, the polymer comprises a linear and/or crosslinked basic backbone selected from the group polystyrene, polypropylene, polyethylene, poly(meth)acrylate, poly(meth)acrylamide, and also copolymers of any desired mixtures thereof.

This has proven to be advantageous for a wide range of applications within the present invention since in this way the desired solubility can be achieved very easily.

According to one preferred embodiment of the invention, the polymer used is linear or has a degree of crosslinking of 20%.

According to one preferred embodiment of the invention, the at least one N-containing carboxylate chelator is selected from the group comprising

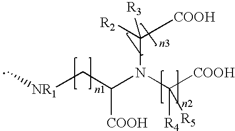

where R₁, R₂, R₃, R₄ and R₅, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5;

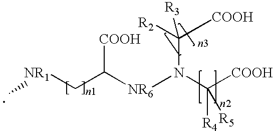

where R₁, R₂, R₃, R₄, R₅ and R₆, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5;

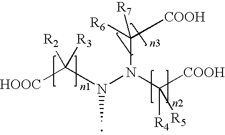

where R₁, R₂, R₃, R₄, R₅, R₆ and R₇, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5;

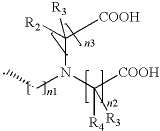

where R₁, R₂, R₃ and R₄, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5;

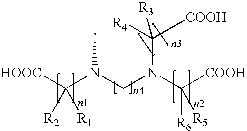

where R₁, R₂, R₃, R₄, R₅ and R₆, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5 and n4 is from 1 to 5;
   or mixtures thereof.

It may be noted that

[symbol]

is used to refer to the position or bond in the chelator via which the chelator is bound to the basic backbone—if appropriate via further “bridges” or chemical functionalities.

This binding can take place e.g. via all chemical functionalities or “bridges” known to the person skilled in the art; in practice, for many applications, the following have in particular proven useful:
ester/amide linkages
bindings via opening of epoxides or thiiranes
bindings via olefin metathesis reactions, in particular with the assistance of “Grubbs catalysts”
bindings via thioether or sulfonic acid groups
imine formations via “Schiff's base” reactions and/or reductive amination, either via reaction with complex hydrides such as sodium cyano-borohydride et al. or via “Staudinger chemistry”
binding to aryl groups via Suzuki/Sonogashira or Heck couplings
Diels-Alder reactions or [3+2] dipolar cycloadditions.

General group definition: within the description and the claims, general groups, such as e.g.: alkyl, alkenyl, alkynyl, alkoxy, aryl etc. are claimed and described. Unless described otherwise, preference is given to using the following groups within the generally described groups within the context of the present invention:
Alkyl: linear and branched C1-C8-alkyls,
Alkenyl: C2-C8-alkenyl,
Alkynyl: C2-C8-alkynyl,
Cycloalkyl: C3-C8-cycloalkyl,
Alkoxy: C1-C6-alkoxy,
Aryl: selected from aromatics with a molecular weight below 300 Da.
Halogen: selected from the group comprising: F; Cl; Br and I,
Haloalkyl: selected from the group comprising mono, di, tri-, poly and perhalogenated linear and branched C1-C8-alkyls Pseudohalogen: selected from the group comprising —CN, —SCN, —OCN, N3, —CNO, —SeCN.

According to one preferred embodiment, at least some of the chelators of the polymer are or can be complexed with a metal which is preferably selected from the group comprising Co, Ni, Fe, Zn, Cu, Mn or mixtures thereof.

This has proven to be helpful especially for the reversible binding of so-called “His-tagged” biomolecules for many applications of the present invention. Here, within the context of the present invention, “His-tagged” proteins are in particular those proteins which have a sequence of several, preferably 6-10, histidine units which may be interrupted by further amino acids.

It may be noted that the solubility values and chelator concentrations stated above refer in each case to uncomplexed polymers.

The present invention moreover relates to a microtiter plate comprising at least one surface area provided with a polymer according to the invention.

According to one preferred embodiment of the invention, the polymer is present as a monolayer.

Preferably, the microtiter plate is produced by treating the surface area to be provided with the polymer with a solution comprising ≧5 mg/ml of polymer, leaving this to act for an adequate time period and then pipetting off the solution.

Preferably, the microtiter plate is produced by treating the surface area to be provided with the polymer with a solution comprising the polymer and removing the solvent by evaporation. This production method has proven useful particularly when readily volatile compounds such as e.g. ethanol are selected as solvents. In this case, the solvent can often be removed simply by leaving it to stand.

The present invention moreover relates to a method for the at least reversible binding of a biomolecule, preferably of a His-containing molecule, comprising
(a) provision of a surface provided with a polymer according to the invention, preferably of a microtiter plate
(b) treatment of the surface with a solution which comprises at least one His-containing molecule.

The present invention moreover relates to a method of identifying a biomolecule, preferably of a His-containing molecule in a preferably aqueous solution, comprising
(a) provision of a surface provided with a polymer according to the invention, preferably of a microtiter plate
(b) treatment of the surface with the solution
(c) detection of the molecule.

According to one preferred embodiment of the invention, step (c) takes place by means of optical and/or spectroscopic methods.

According to one preferred embodiment of the invention, the methods according to the invention additionally comprise the step (z) of detachment of the molecule from the polymer.

According to one preferred embodiment of the invention, step (z) takes place through treatment with histidine and/or imidazole.

The present invention moreover relates to the use of a polymer according to the invention and/or of a microtiter plate according to the invention for identifying biomolecules, preferably His-tagged molecules in a preferably aqueous solution.

The present invention moreover relates to the use of a polymer according to the invention and/or of a microtiter plate according to the invention for the at least partial separating off of biomolecules, preferably of His-tagged molecules in a preferably aqueous solution.

The aforementioned components, and also the claimed components and components to be used according to the invention described in the working examples are not subject to any particular exception conditions with regard to their size, shape, material selection and technical conception, meaning that the selection criteria known in the field of application can be applied without restriction.

Further details, features and advantages of the subject matter of the invention arise from the dependent claims and also from the description below, the relevant examples, which illustrate—by way of example—several working examples and possible uses of the present invention.

It goes without saying that the examples below should be regarded as purely illustrative and are not intended to constitute a restriction of the present invention, which is stipulated exclusively by the claims.

### A) Ni-NTA Functionalized methyl methacrylate-co-methacrylic acid polymer

5 g of poly(methyl methacrylate-co-methacrylic acid), Mw 34 000, 1/0.16 (Aldrich, Cat.#376914) are treated in a 250 ml round-bottomed flask with 100 ml of Millipore water and the pH of the suspension is adjusted to 6.0. 1 g of N-(3-dimethylaminopropyl)-N′-ethylcarbodiimide (EDC) is added and the mixture is left to react on a rotary evaporator at RT and 100 rpm for 30 minutes. The mixture is then filtered through a glass suction filter, por. 4 (standard data relating to the porosity or pore size), and the residue is immediately taken up in a solution of 10 g of 6-aminocaproic acid in Millipore water, pH 7.5. The mixture is left to react on a rotary evaporator for two hours at RT and 100 rpm, then cooled to 0° C. and then filtered again through a glass suction filter, por. 4. The residue is then washed with 25 ml of chilled Millipore water and thoroughly sucked dry. The residue is then suspended again in 100 ml of Millipore water and 1 g of EDC is added. The mixture is then left to react for 30 minutes on a rotary evaporator at 100 rpm and RT and then the mixture is filtered again through the glass suction filter. The residue is then immediately admixed with 25 ml of NTA solution and 75 ml of Millipore water and left to react on a rotary evaporator for two hours at RT and 100 rpm. The mixture is then left to cool overnight and filtered through a glass suction filter, por. 4. The residue is then washed with 25 ml of ice-cooled demin. water, thoroughly sucked dry and taken up in 100 ml of a 1% strength nickel sulfate solution. The mixture is left to react for two hours on a rotary evaporator at RT and 100 rpm, is then filtered again with suction, washed twice with in each case 25 ml of ice-cold Millipore water and thoroughly sucked dry, and then the resulting product is dried at RT in a vacuum drying cabinet.

The polymer produced in this way has a solubility of 10 mg/ml in water and a chelator concentration of 15%.

### B) Ni-NTA Functionalized Polyvinylphenol

5 g of polyvinylphenol (Polysciences, Cat. #06527) are dissolved in 100 ml of 1,4-dioxane in a 250 ml round-bottomed flask and treated with 2 g of sodium hydroxide beads and 4.9 ml of epichlorohydrin. The reaction mixture is suspended on a rotary evaporator and reacted for four hours at 100 rpm and 50° C. The readily volatile constituents are then firstly distilled off on the rotary evaporator (100 mbar, 60° C.) and then in the high-vacuum plant (heat to 50° C.) until all of the epichlorohydrin has escaped. In order that no adhesions remain, the dry residue is scraped out of the flask and admixed with a mixture of 25 ml of NTA solution and 75 ml of Millipore water. The mixture is left to react overnight (16 h) at 75° C. on a rotary evaporator. On the following morning, the product mixture is placed in the freezer at −20° C. for one day and then filtered, if a precipitate is present, via a glass suction filter, por. 4. The product is washed with 25 ml of ice-cooled demin. water and thoroughly sucked dry.

The polymer produced in this way has a solubility of 20 mg/ml in water and a chelator concentration of 50%.

The polymer is then taken up in 100 ml of a 1% strength nickel sulfate solution. The mixture is left to react for two hours at RT and 100 rpm on a rotary evaporator, then filtered again with suction, and the product is washed twice with in each case 25 ml of ice-cold Millipore water, thoroughly sucked dry and then dried at RT in a vacuum drying cabinet.

### C) Ni-IDA Modification of polystyrene-co-allyl alcohol

5 g of polystyrene-co-allyl alcohol (Aldrich, Cat. #19,110-8) are dissolved in 100 ml of 1,4-dioxane in a 250 ml round-bottomed flask and admixed with 2 g of sodium hydroxide beads and 4.9 ml of epichlorohydrin. The reaction mixture is suspended on a rotary evaporator and reacted for four hours at 100 rpm and 50° C. The readily volatile constituents are then distilled off firstly on the rotary evaporator (100 mbar, 60° C.) and then on a high-vacuum plant (heat to 50° C.) until all of the epichlorohydrin has escaped. In order that no adhesions remain, the dry residue is scraped from the flask and admixed with a solution of 5 g of iminodiacetic acid in 95 ml of 500 mM sodium hydroxide solution. The mixture is left to react overnight (16 h) at 75° C. on a rotary evaporator. On the following morning, the product mixture is placed in the freezer at −20° C. for one day and then filtered, if a precipitate is present, via a glass suction filter, por. 4. The product is washed with 25 ml of ice-chilled demin. water and thoroughly sucked dry.

The polymer obtained in this way has a solubility of 25 mg/ml in water and a chelator concentration of 40%.

The polymer is then taken up in 100 ml of a 100 mM nickel chloride solution. The mixture is left to react for two hours at RT and 100 rpm on a rotary evaporator, then filtered again with suction, and the product is washed twice with in each case 25 ml of ice-cold 50 mM tris-buffer, pH 7.0, then 2× with in each case 25 ml of ice-cold Millipore water, thoroughly sucked dry and then dried at RT in a vacuum drying cabinet.

### D) Poly(4-vinylphenol), Modified with Carboxymethyl Aspartate

5 g of polyvinylphenol (Polysciences, Cat. #06527) are suspended in 50 ml of a 1 mol/L sodium hydroxide solution. After a contact time of half an hour, 4.9 ml (63 mmol) of epichlorohydrin are added and the reaction mixture is stirred for 4 h at 60° C. on a rotary evaporator. The mixture is then filtered over a glass frit, por. 3 and the residue is washed five times with 50 ml of demin. water. The residue is then taken up with 50 ml of 1 mol/1 sodium hydroxide solution and admixed with 8.4 g (63 mmol) of L-aspartic acid. The mixture is left to react on the rotary evaporator for 4 h at 80° C. and then cooled. On the following morning, the suspension is filtered with suction and washed five times with 50 ml of demin. water.

The residue is taken up in 50 ml of a 1.5 mol/1 NaOH and admixed with 8.8 g (63 mmol) of bromoacetic acid. The reaction product is heated at 60° C. for 16 hours on the rotary evaporator, cooled, filtered with suction and washed five times with 50 ml of demin. water.

The residue is then admixed with 75 ml of a mol/1 CoSO₄ solution and incubated for 4 h at RT on the rotary evaporator. The mixture is then filtered with suction and the residue is washed five times with in each case 50 ml of demin. water. After thoroughly sucking dry, the polymer is dried in a vacuum drying cabinet at 40° C.

The polymer produced in this way has a solubility of 20 mg/ml in water and a chelator concentration of 50%.

### Applications:

### E) Direct Protein Detection Via Binding to Various Ni-NTA- or IDA- and Carboxymethyl Aspartate-Modified Polymers by Means of Pre-Coating

An aqueous solution of the polymer with a concentration of 1.5 mg/ml from preparation procedure A) to D) is placed into the wells of a microtiter plate. It is left to act for 30 minutes, then the polymer solution is removed by pipetting, the plate is washed twice with Millipore water and then the coated plate is dried.

200 μl of a protein concentration series of 6×His tagged GFP protein in PBS/BSA buffer (adjusted to pH 7.2-7.5) containing 0, 2, 5, 10, 20, 50, 100 and 200 ng of protein are added. They are then left to incubate for one hour at room temperature. The solution is removed by pipetting from the microtiter plate and the wells are cleaned by washing four times with PBS/Tween buffer. 200 μl of PBS buffer are then added and the fluorescence is measured at an excitation wavelength of 488 nm and an emission wavelength of 511 nm.

### F) Protein Detection Via Binding to Various Ni-NTA- or IDA- and Carboxymethyl Aspartate-Modified Polymers (Immunoassay) by Means of Pre-Coating

An aqueous solution of the polymer with a concentration of 1.5 mg/ml from preparation procedure A) to D) is added to the wells of a microtiter plate. It is left to act for 30 minutes, the polymer solution is removed by pipetting, the plate is washed twice with Millipore water and then the coated plate is dried.

200 μl of a protein concentration series of 6×His and Tag 100 labeled thioredoxin in PBS/BSA buffer (adjusted to pH 7.2-7.5) containing 0, 2, 5, 10, 20, 50, 100 and 200 ng of protein are added. They are then left to incubate for one hour at room temperature. The solution is removed from the microtiter plate by pipetting and the wells are cleaned by washing four times with PBS/Tween buffer. 200 μl of a 1/1000 dilution of the first antibody are added and they are left to incubate on a shaker for 60 minutes at RT. Washing is then carried out four times with PBS/Tween buffer. After adding 200 μl of a 1/2000 dilution in PBS/BSA buffer of the second antibody, the microtiter plate is left to incubate for 60 minutes at RT on a shaker. Washing is then carried out four times with PBS/Tween buffer. 200 μl of the substrate solution are then added and the reaction is stopped after 20 minutes with 50 μl of 3 mol/1 HCl. The absorption is then measured at 492 nm.

### G) Protein Detection Via Binding to Various Ni-NTA- or IDA- and Carboxymethyl Aspartate-Modified Polymers without Pre-Coating

200 μl of a protein polymer concentration series in PBS/BSA buffer (adjusted to pH 7.2-7.5) of GFP protein containing 0, 2, 5, 10, 20, 50, 100 and 200 ng of protein with 300 ng of dissolved polymer [prepared according to example A) to D)] are placed in the polymer solution. They are then left to incubate for one hour at room temperature. The solution is removed from the microtiter plate by pipetting and the wells are cleaned by washing four times with PBS/Tween buffer. 200 μl of a 1/2000 dilution in PBS/BSA buffer of the first antibody are then added and they are left to incubate for 60 minutes at RT on a shaker. Washing is then carried out four times with PBS/Tween buffer. After adding 200 μl of a 1/10 000 dilution in PBS/BSA buffer of the second antibody, the microtiter plate is left to incubate for 60 min at RT on a shaker. Washing is then carried out four times with PBS/BSA buffer. 200 μl of the substrate solution are then added and the reaction is stopped after 20 minutes with 50 μl of 3 mol/1 HCl. The absorption is then measured at 492 nm.

### H) Protein Detection Via Binding to Various Ni-NTA- or IDA- and Carboxymethyl Aspartate-Modified Polymers Without Pre-Coating

200 μl of a protein polymer concentration series in PBS/BSA buffer (adjusted to pH 7.2-7.5) of thioredoxin containing 0, 2, 5, 10, 20, 50, 100 and 200 ng of protein with 300 ng of dissolved polymer [prepared according to example A) to D)] are added to the polymer solution. They are then left to incubate for one hour at room temperature. The solution is removed from the microtiter plate by pipetting and the wells are cleaned by washing four times with PBS/Tween buffer. 200 μl of a 1/1000 dilution in PBS/BSA buffer of the first antibody are then added and they are left to incubate for 60 minutes at RT on a shaker. Washing is then carried out four times with PBS/Tween buffer. After adding 200 μl of a 1/2000 dilution in PBS/BSA buffer of the second antibody, the microtiter plate is left to incubate for 60 minutes at RT on a shaker. Washing is then carried out four times with PBS/Tween buffer. 200 μl of the substrate solution are then added and the reaction is stopped after 20 minutes with 50 μl of 3 mol/1 HCl. The absorption is then measured at 492 nm.

1. A functionalized polymer which has a solubility of 10 mg/ml in at least one solvent having an E_{T}(30) value of ≧45 to ≦65 and is functionalized with at least one N-containing carboxylate chelator.

2. The polymer as claimed in claim 1, where the polymer has a chelator concentration of ≧2% by weight to ≦75% by weight.

3. The polymer as claimed in claim 1 or 2, where the polymer is linear or has a degree of crosslinking of ≦20%.

4. The polymer as claimed in claim 1, where the polymer comprises a linear and/or crosslinked basic backbone selected from the group polystyrene, polypropylene, polyethylene, poly(meth)acrylate, poly(meth)acrylamide, and also copolymers of any desired mixtures thereof.

5. The polymer as claimed in claim 1, where the at least one N-containing carboxylate chelator is selected from the group comprising 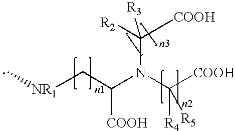
where R₁, R₂, R₃, R₄ and R₅, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5; 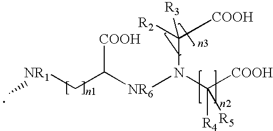
where R₁, R₂, R₃, R₄, R₅ and R₆, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5; 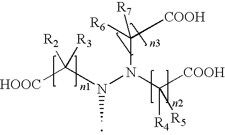
where R₁, R₂, R₃, R₄, R₅, R₆ and R₇, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5; 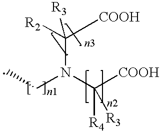
where R₁, R₂, R₃ and R₄, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5; 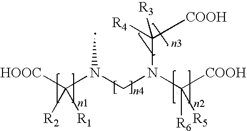
where R₁, R₂, R₃, R₄, R₅ and R₆, in each case independently of one another, are selected from the group comprising hydrogen, halogen, alkyl, alkenyl, alkynyl, cycloalkyl, haloalkyl, aryl, alkoxy, pseudohalogen;
n1, n2 and n3, in each case independently of one another, are 0 to 5 and n4 is from 1 to 5;
or mixtures thereof.

6. A microtiter plate comprising at least one surface area provided with a polymer according to claim 1.

7. A microtiter plate as claimed in claim 6, where the polymer is present as a monolayer.

8. A method for the at least reversible binding of a biomolecule, preferably of a His-containing molecule, comprising
(a) provision of a surface provided with a polymer according to claim 1,
(b) treatment of the surface with a solution which comprises at least one His-containing molecule.

9. A method of identifying a biomolecule, preferably of a His-containing molecule, in a preferably aqueous solution, comprising
(a) provision of a surface provided with a polymer according to claim 1,
(b) treatment of the surface with the solution
(c) detection of the molecule.

10. The method as claimed in claim 9, where step (c) takes place by means of optical and/or spectroscopic methods.

11. The method as claimed in claim 8, additionally comprising the step (z) of detachment of the molecule from the polymer.

12. The method as claimed in claim 11, where step (z) takes place through treatment with histidine and/or imidazole.

13. The use of a polymer as claimed in claim 1 for identifying biomolecules, preferably His-tagged molecules in a preferably aqueous solution.

14. The use of a polymer as claimed in claim 1 for the at least partial separating off of biomolecules, preferably of His-tagged molecules, from/in a preferably aqueous solution.
